(19) United States
(12) Patent Application Publication
(10) Pub. No.: US 2020/0316907 A1
(43) Pub. Date: Oct. 8, 2020

(54) FIBRE-REINFORCED FOAM MATERIALS

(71) Applicant: BASF SE, Ludwigshafen am Rhein (DE)

(72) Inventors: Robert STEIN, Ludwigshafen am Rhein (DE); Holger RUCKDAESCHEL, Ludwigshafen am Rhein (DE); Rene ARBTER, Ludwigshafen am Rhein (DE); Tim DIEHLMANN, Ludwigshafen am Rhein (DE); Gregor DAUN, Ludwigshafen am Rhein (DE); Marc Claude MARTIN, Lemfoerde (DE)

(21) Appl. No.: 16/303,403

(22) PCT Filed: May 17, 2017
(86) PCT No.: PCT/EP2017/061871

§ 371 Date: Nov. 20, 2018

(30) Foreign Application Priority Data
May 25, 2016 (EP) 16171419.1

(51) Int. Cl. B32B 7/09; B29C 70/02; B29C 70/24; B29D 99/00; B32B 5/18; B32B 5/02; B32B 5/12; B32B 5/24; B32B 27/06; F03D 1/06

(52) U.S. Cl. CPC B32B 7/09; B32B 2603/00; B29C 70/24; B29D 99/0025; B32B 5/18; B32B 5/022; B32B 5/024; B32B 5/12; B32B 5/245; B32B 27/065; F03D 1/0675; B32B 2250/40; B32B 2260/023; B32B 2260/046; B32B 2307/51; B32B 2307/732; B29C 70/026

(57) ABSTRACT

The present invention relates to a molding which comprises a foam and at least one fiber (F). The fiber (F) has a first part (FT1), a second part (FT2) and a third part (FT3). The third part (FT3) of the fiber (F) connects the first part (FT1) and the second part (FT2) of the fiber (F) and is arranged on a second side of the foam. A first region (FB11) of the first part (FT1) of the fiber (F) and a first region (FB12) of the second part (FT2) of the fiber (F) are located inside the molding and are not in contact. A second region (FB21) of the first part (FT1) of the fiber (F) and a second region (FB22) of the second part (FT2) of the fiber (F) project from a first side of the foam. The present invention further relates to a process for producing the moldings according to the invention and to a panel which comprises the molding according to the invention and at least one layer (S1) and also to a process for producing the panel. The present invention further relates to the use of the molding/of the panel, for example as a rotor blade in wind turbines.

The present invention relates to a molding which comprises a foam and at least one fiber (F). The fiber (F) has a first part (FT1), a second part (FT2) and a third part (FT3). The third part (FT3) of the fiber (F) connects the first part (FT1) and the second part (FT2) of the fiber (F) and is arranged on a second side of the foam. A first region (FB11) of the first part (FT1) of the fiber (F) and a first region (FB12) of the second part (FT2) of the fiber (F) are located inside the molding and are not in contact. A second region (FB21) of the first part (FT1) of the fiber (F) and a second region (FB22) of the second part (FT2) of the fiber (F) project from a first side of the foam. The present invention further relates to a process for producing the moldings according to the invention and to a panel which comprises the molding according to the invention and at least one layer (S1) and also to a process for producing the panel. The present invention further relates to the use of the molding/of the panel, for example as a rotor blade in wind turbines.

WO 2006/125561 relates to a process for producing reinforced cellular materials. A first process step comprises initially producing in the cellular material at least one hole which extends from a first surface to a second surface of the cellular material. On the second surface of the cellular material at least one fiber bundle is provided and this fiber bundle is then pulled through the hole to the first side of the cellular material with a needle which is passed from the first surface of the cellular material through the hole to the second surface of the cellular material. After the process steps the fiber bundle is located partially inside the cellular material to fill the corresponding hole while the fiber bundle partially projects from the respective sides of the cellular material.

The process described in WO 2006/125561 makes it possible to produce sandwich-like components comprising a core made of the cellular material and at least one fiber bundle. Resin layers and fiber-reinforced resin layers may be applied to the surfaces of this core to produce the sandwich component. Described as the cellular material are for example polyvinyl chlorides or polyurethanes and as the fiber bundle are carbon fibers, nylon fibers, glass fibers and polyester fibers. The sandwich-like components according to WO 2006/125561 are suitable for use in aircraft construction.

WO 2006/125561 does not disclose that the fiber present in the molding comprises a first part, a second part and a third part, wherein the first region of the first part and the first region of the second part are not in contact and the third part connects the first part and the second part of the fiber.

WO 2012/138445 likewise describes a process for producing composite materials, wherein a multiplicity of elongate strips of a cellular material having a low density are employed. A double-ply fiber mat is introduced between the respective strips. Through the use of resin said mat effects an adhesive bonding of the individual strips to form the composite materials. The cellular material is selected from balsa wood, elastic foams or fiber-reinforced composite foams. The double-ply fiber mats are for example porous glass fiber mats. The adhesive used is a resin that may be for example a polyester, an epoxy resin or a phenolic resin or a heat-activated thermoplastic, for example polypropylene or polyethylene terephthalate (PET). WO 2012/138445 does not disclose that individual fibers or fiber bundles may be incorporated into the cellular material. Instead it employs exclusively fiber mats which constitute a bonding element in the context of an adhesive bonding of the individual strips using resin to obtain the composite core panel.

WO 2011/012587 likewise relates to a process for producing a core material comprising a fiber for the production of panels. The core material is produced when fibers are laid onto a surface of a so-called “cake” of lightweight material and are partially or completely introduced into this cake using a needle. The introduction of the fibers is effected by a so-called “tufting process”. The “cake” may be formed from polyurethane foams, polyester foams, polyethylene terephthalate foams, polyvinyl chloride foams or a phenolic foam, in particular from a polyurethane foam. The fibers used may be any type of single or multiple threads and other yarns.

The thus produced core materials may be a constituent of a panel, wherein the core is then surrounded on one or two sides by a resin matrix or combinations of resin matrices with fibers in a sandwich-like configuration. However, WO 2011/012587 does not describe that the fiber has a first part, a second part and a third part, wherein the third part connects the first part and the second part of the fiber and the first part with a first region and the second part with a first region are located inside the molding and surrounded by the foam.

U.S. Pat. No. 6,187,411 describes composite sandwich panels and a process for the production thereof. The composite sandwich panels comprise a core material that is fiber-reinforced. The core material is a closed-cell foam such as for example polyurethane, phenol, isocyanate or the like. The fibers are introduced into the core such that they form loops on one side. These loops are secured using a lower thread. The fibers are therefore introduced into the core material as a chain stitch or lock stitch.

U.S. Pat. No. 6,187,411 does not describe that the fiber is pulled from the second side to the first side of the core material with a needle. Instead, it describes that a fiber is pushed with a needle from the first side to the second side.

U.S. Pat. Nos. 5,624,622 and 4,196,251 describe similar processes and materials to U.S. Pat. No. 6,187,411. In these processes too a loop of the fiber is first formed on one side of a core material and this loop is subsequently secured via a lower thread. Thus a chain stitch or a lock stitch is also used in the processes described in U.S. Pat. Nos. 5,624,622 and 4,196,251.

US 2010/0266833 describes fiber-reinforced core panels and a process for the production thereof. The fiber-reinforced core panels comprise a fiber-reinforced cellular material, resin and fibrous and non-fibrous outer layers. The core panels may comprise fibers introduced by a tufting process. This comprises using needles to introduce rovings from a first side upon piercing of the cellular material. US 2010/0266833 thus does not describe that the fiber is pulled from the second side to the first side of the core material with a needle but rather describes that a fiber is pushed from the first side to the second side with a needle.

US 2010/0255251 describes a fiber-reinforced composite panel which comprises two fibrous surfaces and a core material. In the composite panel fibers of the surface materials have been impressed into the core by needlepunching. Thus also in the process described in US 2010/0255251 the fiber is not pulled from the second side to the first side of the core material with a needle but rather a fiber is pushed from the first side to the second side with a needle.

The processes according to US 2010/0266833 and US 2010/0255251 are both tufting processes. The disadvantage of said processes is that the fibers in some cases remain in the foam incompletely and in some cases are pulled out by the needles and in addition the fibers break. Furthermore the securing of the fibers in the foam is only inadequate.

The present invention accordingly has for its object to provide novel moldings.

This object is achieved by a molding comprising a foam which has a first side and a second side and at least one fiber (F) which has a first part (FT1), a second part (FT2) and a third part (FT3), wherein
a first region (FB11) of the first part (FT1) of the fiber (F) is located inside the molding and surrounded by the foam and a second region (FB21) of the first part (FT1) of the fiber (F) projects from the first side of the foam and
a first region (FB12) of the second part (FT2) of the fiber (F) is located inside the molding and surrounded by the foam and a second region (FB22) of the second part (FT2) of the fiber (F) projects from the first side of the foam and
the third part (FT3) of the fiber (F) connects the first part (FT1) and the second part (FT2) of the fiber (F) and is arranged on the second side of the foam and
the first region (FB11) of the first part (FT1) of the fiber (F) and the first region (FB12) of the second part (FT2) of the fiber (F) are not in contact,

wherein the molding is obtainable by a process comprising the following steps a) to k):
a) providing the foam,
b) providing the fiber (F) on the second side of the foam,
c) providing a first hole per fiber (F) in the foam, wherein the first hole extends from the first side to the second side of the foam,
d) providing a second hole per fiber (F) in the foam, wherein the second hole extends from the first side to the second side of the foam,
e) passing through a needle from the first side of the foam through the first hole to the second side of the foam,
f) securing a first part (FT1) of the fiber (F) to the needle on the second side of the foam,
g) returning the needle together with the first part (FT1) of the fiber (F) through the first hole to the first side of the foam,
h) passing through a needle from the first side of the foam through the second hole to the second side of the foam,
i) securing the second part (FT2) of the fiber (F) to the needle on the second side of the foam,
j) returning the needle together with the second part (FT2) of the fiber (F) through the second hole to the first side of the foam and
k) obtaining the molding.

The molding according to the invention allows in advantageous fashion a subsequent conversion, in particular also by material-removing processes, wherein only very few, if any, fibers are pulled out of the molding. The fibers have thus been introduced into the molding according to the invention particularly securely, on the one hand as a result of the connection of the first part (FT1) of the fiber (F) and the second part (FT2) of the fiber (F) via the third part (FT3) of the fiber (F) and on the other hand as a result of the production of the molding. Particularly high pullout resistances for the fiber (F) in the molding are therefore obtained.

Since in a preferred embodiment the third part (FT3) of the fiber (F) is aligned parallel to the second side of the molding and is in contact therewith this affords in the molding according to the invention a uniform surface which constitutes an exact edge of reference for further processing steps. This ensures a high dimensional accuracy in the further converting of the molding. In addition this preferably uniform surface improves the drapability of the moldings according to the invention and the inherent stability upon converting (for example during introduction of slots or scarffings into the molding) increases, thus likewise improving the handling of the moldings according to the invention

The moldings of the invention also advantageously feature low resin absorption with simultaneously good interfacial binding. This effect is important particularly when the molding according to the invention is further processed into the panels according to the invention.

A further improvement in bonding coupled with reduced resin absorption is made possible in accordance with the invention by the fiber reinforcement of the foams in the moldings according to the invention or the panels that result therefrom. According to the invention the fiber (F) (individually or preferably in the form of a fiber bundle) may advantageously be introduced into the foam initially in a dry state and by mechanical processes. The fiber (F)/the fiber bundle has an overhang at the respective foam surfaces (second region (FB21), second region (FB22) and third part (FT3) of the fiber (F)) and thus enable an improved bonding/a direct joining with the corresponding outer plies in the panel according to the invention. This is the case in particular when as an outer ply according to the invention at least one further layer (S1) is applied to the molding according to the invention to form the panel. It is preferable when two layers (S1) which may be identical or different are applied. It is particularly preferable when two identical layers (S1), in particular two identical fiber-reinforced resin layers, are applied to opposite sides of the molding according to the invention to form the panel according to the invention. Such panels are also referred to as “sandwich material” and the molding according to the invention may also be referred to as “core material”.

The panels according to the invention therefore feature a low resin absorption in conjunction with a good peel strength and a good shear strength and a high shear modulus. Moreover, high strength and stiffness properties can be specifically adjusted through the choice of fiber types and the proportion and arrangement thereof. The effect of low resin absorption is important because a common aim in the use of such panels (sandwich materials) is that the structural properties are to be increased while attaining the lowest possible weight. When using for example fiber-reinforced outer plies not only the actual outer plies and the molding but also the resin absorption of the molding contribute to the total weight. However, the moldings according to the invention/the panels according to the invention can reduce resin absorption, thus allowing weight and cost savings.

Further improvements/advantages may be achieved when the first part (FT1) of the fiber (F) and/or the second part (FT2) of the fiber (F) are each independently of one another introduced into the foam at an angle α of 0° to 60°, preferably of 0° to 50°, more preferably of 0° to 15° or of 10° to 70°, in particular of 30° to 60°, more preferably of 30° to 50°, yet more preferably of 30° to 45°, in particular of 45°, relative to the thickness direction (d) of the molding. Introduction at an angle α of 0° to <90° is generally technically feasible.

Additional improvements/advantages can be achieved when the fibers (F) are introduced into the foam not only parallel to one another but when further fibers (F) are also introduced at an angle β to one another which is preferably in the range from >0° to 180°. This additionally achieves an improvement in the mechanical properties of the molding.

It is likewise advantageous when in the panels according to the invention the resin (outer) layer is applied by liquid injection methods or liquid infusion methods in which the fibers can be impregnated with resin during processing and the mechanical properties improved. This can additionally result in cost savings.

The present invention is further elucidated hereinbelow.

According to the invention, the molding comprises a foam and at least one fiber (F). The foam has a first side and a second side. The first side of the foam is preferably opposite the second side of the foam.

The foam may be based on any polymers known to those skilled in the art.

The foam is for example based on at least one polymer selected from polystyrene, polyester, polyphenylene oxide, a copolymer prepared from phenylene oxide, a copolymer prepared from styrene, polyaryl ether sulfone, polyphenylene sulfide, polyaryl ether ketone, polypropylene, polyethylene, polyamide, polyamide imide, polyether imide, polycarbonate, polyacrylate, polylactic acid, polyvinyl chloride, polyurethane or a mixture thereof.

It is preferable when the foam is based on at least one polymer selected from polystyrene, polyphenylene oxide, a mixture of polystyrene and polyphenylene oxide, polyethylene terephthalate, polycarbonate, polyether sulfone, polysulfone, polyether imide, a copolymer prepared from styrene, or a mixture of copolymers prepared from styrene. It is particularly preferable when the polymer is polystyrene, a mixture of polystyrene and poly(2,6-dimethylphenylene oxide), a mixture of a styrene-maleic anhydride polymer and a styrene-acrylonitrile polymer, or a styrene-maleic anhydride polymer (SMA).

Polyphenylene oxide is preferably poly(2,6-dimethylphenylene ether), which is also referred to as poly(2,6-dimethylphenylene oxide).

Suitable copolymers prepared from phenylene oxide are known to those skilled in the art. Suitable comonomers for phenylene oxide are likewise known to those skilled in the art.

A copolymer produced from styrene preferably comprises as a comonomer to styrene a monomer selected from α-methylstyrene, ring-halogenated styrenes, ring-alkylated styrenes, acrylonitrile, acrylic esters, methacrylic esters, N-vinyl compounds, maleic anhydride, butadiene, divinylbenzene and butanediol diacrylate.

The foam has for example been produced from a particle foam, an extruded foam, a reactive foam and/or a batch foam. The foam has preferably been produced from an extruded foam, especially preferably from an extruded foam produced in a process comprising the following steps:
I) providing a polymer melt in an extruder,
II) introducing at least one blowing agent into the polymer melt provided in step I) to obtain a foamable polymer melt,
III) extruding the foamable polymer melt obtained in step II) from the extruder through at least one die aperture into an area at lower pressure, with expansion of the foamable polymer melt to obtain an expanded foam,
IV) calibrating the expanded foam from step III) by passing the expanded foam through a shaping tool to obtain the extruded foam,
V) optional material-removing processing of the extruded foam obtained in step IV),

wherein
i) the polymer melt provided in step I) optionally comprises at least one additive, and/or
ii) at least one additive is optionally added to the polymer melt during step II) and/or to the foamable polymer melt between step II) and step III), and/or
iii) at least one additive is optionally applied during step III) to the expanded foam and/or during step IV) to the expanded foam, and/or
iv) at least one layer (S2) is optionally applied to the extruded foam during and/or directly after step IV).

Suitable methods for provision of the polymer melt in the extruder in step I) are in principle all methods known to those skilled in the art; for example, the polymer melt can be provided in the extruder by melting an already ready-polymerized polymer. The polymer can be melted directly in the extruder; it is likewise possible to feed the polymer to the extruder in molten form and thus to provide the polymer melt in the extruder in step I). It is likewise possible that the polymer melt is provided in step I) in that the corresponding monomers required for preparation of the polymer of the polymer melt react with one another in the extruder to form the polymer and hence the polymer melt is provided.

A polymer melt is understood in the present context to mean that the polymer is above the melting temperature (T_{M}) in the case of semicrystalline polymers or the glass transition temperature (T_{G}) in the case of amorphous polymers.

Typically, the temperature of the polymer melt in process step I) is in the range from 100 to 450° C., preferably in the range from 150 to 350° C. and especially preferably in the range from 160 to 300° C.

In step II), at least one blowing agent is introduced into the polymer melt provided in step I). Methods for this purpose are known per se to those skilled in the art.

Suitable blowing agents are selected, for example, from the group consisting of carbon dioxide, alkanes such as propane, isobutane and pentane, alcohols such as methanol, ethanol, 1-propanol, 2-propanol, 1-butanol, 2-butanol, 2-methylpropanol and tert-butanol, ethers such as dimethyl ether, ketones such as acetone and methyl ethyl ketone, halogenated hydrocarbons such as hydrofluoropropene, water, nitrogen and mixtures of these.

In step II), the foamable polymer melt is thus obtained. The foamable polymer melt comprises typically in the range from 1% to 15% by weight of the at least one blowing agent, preferably in the range from 2% to 10% by weight and especially preferably in the range from 3% to 8% by weight, in each case based on the total weight of the foamable polymer melt.

The pressure in the extruder in step II) is typically in the range from 20 to 500 bar, preferably in the range from 50 to 400 bar and especially preferably in the range from 60 to 300 bar.

In step III), the foamable polymer melt obtained in step II) is extruded through at least one die aperture from the extruder into an area at lower pressure, with expansion of the foamable polymer melt to obtain the expanded foam.

Methods of extrusion of the foamable polymer melt are known per se to those skilled in the art.

Suitable die apertures for the extrusion of the foamable polymer melt are all those known to the person skilled in the art. The die aperture may have any desired shape; for example, it may be rectangular, circular, elliptical, square or hexagonal. Preference is given to rectangular slot dies and circular round dies.

In one embodiment, the foamable polymer melt is extruded through exactly one die aperture, preferably through a slot die. In a further embodiment, the foamable polymer melt is extruded through a multitude of die apertures, preferably circular or hexagonal die apertures, to obtain a multitude of strands, the multitude of strands being combined immediately after emergence from the die apertures to form the expanded foam. The multitude of strands may also be combined only in step IV) by being passed through the shaping tool.

Preferably, the at least one die aperture is heated. Especially preferably, the die aperture is heated at least to the glass transition temperature (T_{G}) of the polymer present in the polymer melt provided in step I) when the polymer is an amorphous polymer, and at least to the melting temperature T_{M} of the polymer present in the polymer melt provided in step I) when the polymer is a semicrystalline polymer; for example, the temperature of the die aperture is in the range from 80 to 400° C., preferably in the range from 100 to 350° C. and especially preferably in the range from 110 to 300° C.

The foamable polymer melt is extruded in step III) into an area at lower pressure. The pressure in the area at lower pressure is typically in the range from 0.05 to 5 bar, preferably in the range from 0.5 to 1.5 bar.

The pressure at which the foamable polymer melt is extruded out of the die aperture in step III) is typically in the range from 20 to 600 bar, preferably in the range from 40 to 300 bar and especially preferably in the range from 50 to 250 bar.

In step IV), the expanded foam from step III) is calibrated by passing the expanded foam through a shaping tool to obtain the extruded foam.

The calibration of the expanded foam determines the outer shape of the extruded foam obtained in step IV). Processes for calibration are known per se to those skilled in the art.

The shaping tool may be disposed directly at the die aperture. It is likewise possible that the shaping tool is disposed at a distance from the die aperture.

Shaping tools for calibration of the expanded foam are known per se to those skilled in the art. Suitable shaping tools include, for example, sheet calibrators, roller takeoffs, mandrel calibrators, chain takeoffs and belt takeoffs. In order to reduce the coefficient of friction between the shaping tools and the extruded foam, the tools can be coated and/or heated.

The calibration in step IV) thus fixes the geometric shape of the cross section of the extruded foam of the invention in at least one dimension. Preferably, the extruded foam has a virtually orthogonal cross section. If the calibration is partly undertaken only in particular directions, the extruded foam may depart from the ideal geometry at the free surfaces. The thickness of the extruded foam is determined firstly by the die aperture, and secondly also by the shaping tool; the same applies to the width of the extruded foam.

Suitable methods for material-removing processing, in step V), of the extruded foam obtained in step IV) are in principle all methods known to those skilled in the art. For example, the extruded foam can be subjected to material-removing processing by sawing, milling, drilling or planing. When the extruded foam is a thermoplastic foam, thermoforming is additionally possible, by means of which it is possible to avoid material-removing processing with cutting losses and damage to the fibers (F).

Suitable additives are in principle all additives known to those skilled in the art, for example nucleating agents, flame retardants, dyes, process stabilizers, processing aids, light stabilizers and pigments.

With regard to the layer (S2), which in one embodiment is applied to the extruded foam, the elucidations and preferences described hereinbelow apply.

The foam according to the invention typically comprises cells. As a result of the preferred production of the foam by an extrusion process, in particular by an extrusion process comprising the steps I) to V), typically at least 50%, preferably at least 80%, more preferably at least 90%, of the cells of the foam are anisotropic.

An anisotropic cell has different dimensions in different spatial directions; the largest dimension of the cell is referred to as the a-direction and the smallest dimension is referred to as the c-direction. The third dimension is referred to as the b-direction. The dimensions of the cells may be determined, for example, by means of optical micrographs or scanning electron micrographs.

The anisotropic properties of the cells preferably also result in anisotropic properties of the foam.

For example at least one of the mechanical properties, preferably all mechanical properties of the foam, may be anisotropic and/or at least one of the elastic moduli, preferably all elastic moduli, of the foam may be anisotropic. Likewise the ratio of the compressive strength in the thickness (z-direction) of the foam to the compressive strength in the length (x-direction) of the foam and/or the ratio of the compressive strength in the thickness (z-direction) of the foam to the compressive strength in the width (y-direction) of the foam may be different.

The foam may have any desired dimensions. The foam typically has a thickness (z-direction) in the range of 4 to 200 mm, preferably in the range from 5 to 60 mm, a length (x-direction) of at least 200 mm, preferably of at least 400 mm, and a width (y-direction) of at least 200 men, preferably of at least 400 mm.

The foam also typically has a length (x-direction) of not more than 4000 mm, preferably of not more than 2500 mm, and/or a width (y-direction) of not more than 4000 mm, preferably of not more than 2500 mm.

The foam typically has a density in the range from 10 to 150 kg/m³, particularly preferably in the range from 20 to 100 kg/m³ and especially preferably in the range from 25 to 60 kg/m³. According to the invention the density is determined according to ISO 845 (October 2009 version).

The molding comprises at least one fiber (F).

In the context of the present invention “at least one fiber” (F) is to be understood as meaning precisely one fiber (F) or else two or more fibers (F). Two or more fibers (F) are preferred.

In the context of the present invention the terms “at least one fiber (F)” and “fiber (F)” are used synonymously and therefore have the same meaning.

The fiber (F) in step a) is preferably a single fiber or a fiber bundle, particularly preferably a fiber bundle.

Suitable as the fiber (F) in step a) are all materials capable of forming fibers that are known to those skilled in the art. For example, the fiber (F) in step a) is an organic, inorganic, metallic, ceramic fiber or a combination thereof. A polymeric fiber, basalt fiber, glass fiber, carbon fiber or natural fiber is preferred and a polyaramid fiber, glass fiber, basalt fiber or carbon fiber is especially preferred. A polymeric fiber is preferably a fiber composed of polyester, polyamide, polyaramid, polyethylene, polyurethane, polyvinyl chloride, polyimide and/or polyamide imide. A natural fiber is preferably a fiber composed of sisal, hemp, flax, bamboo, coconut and/or jute.

It is preferable when fiber bundles are provided as the fiber (F) in step b). The fiber bundles are composed of a plurality of individual fibers (filaments). The number of single fibers per bundle is preferably at least 10, particularly preferably 100 to 100 000, especially preferably 300 to 10 000, in the case of glass fibers and 1000 to 50 000 in the case of carbon fibers and most preferably 500 to 5 000 in the case of glass fibers and 2 000 to 20 000 in the case of carbon fibers.

According to the invention the fiber (F) has a first part (FT1), a second part (FT2) and a third part (FT3). A first region (FB11) of the first part (FT1) of the fiber (F) is located inside the molding and is surrounded by the foam. A second region (FB21) of the first part (FT1) of the fiber (F) projects from the first side of the foam. A first region (FB12) of the second part (FT2) of the fiber (F) is likewise located inside the molding and is surrounded by the foam. A second region (FB22) of the second part (FT2) of the fiber (F) projects from the first side. The third part (FT3) of the fiber (F) connects the first part (FT1) and the second part (FT2) of the fiber (F) and is arranged on the second side of the foam. The first region (FB11) of the first part (FT1) of the fiber (F) and the first region (FB12) of the second part (FT2) of the fiber (F) are not in contact.

The first region (FB11) of the first part (FT1) of the fiber (F) and the first region (FB12) of the second part (FT2) of the fiber (F) are therefore separated from one another by the foam.

It is preferable according to the invention when the first region (FB11) of the first part (FT1) of the fiber (F) is aligned parallel to the first region (FB12) of the second part (FT2) of the fiber (F).

In the context of the present invention “parallel” is to be understood as meaning not only precise parallel alignment of the first region (FB11) of the first part (FT1) of the fiber (F) to the first region (FB12) of the second part (FT2) of the fiber (F) but also a deviation from parallel alignment of not more than +/−10°, preferably of not more than +/−5° and especially preferably of not more than +/−1°.

The first part (FT1) of the fiber (F) has preferably been introduced into the molding at an angle α_{FT1} relative to the thickness direction (d) of the molding/to the orthogonal (of the surface) of the first side of the foam. The angle α_{FT1} may take any desired values from 0° to 90°, for example the first part (FT1) of the fiber (F) has been introduced into the foam at an angle α_{FT1} of 0° to 60°, preferably of 0° to 50°, more preferably of 0° to 15° or of 10° to 70°, especially preferably of 30° to 60°, more preferably of 30° to 50°, yet more preferably of 30° to 45°, especially preferably of 45°, relative to the thickness direction (d) of the molding.

The second part (FT2) of the fiber (F) has preferably been introduced into the molding at an angle α_{FT2} relative to the thickness direction (d) of the molding/to the orthogonal (of the surface) of the first side of the foam. The angle α_{FT1} may take any desired values from 0° to 90°, for example the second part (FT2) of the fiber (F) has been introduced into the foam at an angle α_{FT2} of 0° to 60°, preferably of 0° to 50°, more preferably of 0° to 15° or of 10° to 70°, especially preferably of 30° to 60°, more preferably of 30° to 50°, yet more preferably of 30° to 45°, especially preferably of 45°, relative to the thickness direction (d) of the molding.

It is preferable when the first part (FT1) of the fiber (F) and the second part (FT2) of the fiber (F) are introduced into the foam at the same angle α=α_{FT1}=α_{FT2}.

Particularly in this embodiment it is possible for at least two different fibers (F) each having a first part (FT1), a second part (FT2) and a third part (FT3) to be introduced into the foam. The first part (FT1) of each of the at least two fibers (F) then has a first region (FB11) and a second region (FB21) for which the elucidations and preferences described hereinabove apply in each case. The second part (FT2) of each of the at least two fibers (F) likewise has a first region (FB12) and a second region (FB22) for which the elucidations and preferences described hereinabove apply in each case. It is preferable when the first part (FT1) and the second part (FT2) of a fiber (F) have each been introduced into the foam at the same angle α=α_{FT1}=α_{FT2} relative to the thickness direction (d). The angle α_{F1} of the first part (FT1) and of the second part (FT2) of the first fiber (F1) is then preferably distinct from the angle α_{F2} of the first part (FT1) and of the second part (FT2) of the second fiber (F2). The angle α_{F1} is then preferably in the range from 0° to 15° and the angle α_{F2} in the range from 30° to 50° and especially preferably the angle α_{F1} is in the range from 0° to 5° and the angle α_{F2} in the range from 40° to 50°.

It is especially preferable when all fibers (F) and thus also all first parts (FT1) and second parts (FT2) in the molding according to the invention have the same angle α or at least approximately the same angle (deviation of not more than +/−5°, preferably +/−2°, particularly preferably +/−1°). The at least two fibers (F) are then parallel to one another for example.

All fibers (F) may be arranged parallel to one another in the molding. It is likewise possible for two or more fibers (F) to be arranged in the molding at an angle β to one another. In the context of the present invention the angle β is to be understood as meaning the angle between the orthogonal projection of the first part (FT1) of a first fiber (F1) onto the surface of the first side of the molding and the orthogonal projection of the first part (FT1) of the second fiber (F2) onto the surface of the first side of the molding, wherein both fibers (F1 and F2) have been introduced info the molding.

It is accordingly also possible for the second part (FT2) of a first fiber (F1) and the second part (FT2) of a second fiber (F2) to be arranged at an angle β to one another.

It is particularly preferable when all angles β between the first parts (FT1) of two fibers (F) and the second parts (FT2) of two fibers (F) are the same.

Reference is therefore made hereinbelow to the angle β between a first fiber (F1) and a second fiber (F2). It will be appreciated that what is meant here is the angle β between the first part (FT1) of the first fiber (F1) and the first part (FT1) of the second fiber (F2)/the angle β between the second part (FT2) of the first fiber (F1) and the second part (FT2) of the second fiber (F2). The angle β is preferably in the range of β=360°/n, wherein n is an integer. It is preferable when n is in the range from 2 to 6, particularly preferably in the range from 2 to 4. The angle β is 90°, 120° or 180° for example. In a further embodiment the angle β is in the range from 80° to 100°, in the range from 110° to 130° or in the range from 170° to 190°.

In a further embodiment more than two fibers (F) have been introduced at an angle β to one another, for example three or four fibers (F). These three or four fibers (F) may each have two different angles β, β₁ and β₂, to the two adjacent fibers. It is preferable when all fibers (F) have the same angles β=β₁=β₂ to the two adjacent fibers (F). For example when the angle β is 90° the angle β₁ between the first fiber (F1) and the second fiber (F2) is 90°, the angle β₂ between the second fiber (F2) and the third fiber (F3) is 90°, the angle β₃ between the third fiber (F3) and the fourth fiber (F4) is 90° and the angle β₄ between the fourth fiber (F4) and the first fiber (F1) is likewise 90°. The angles β between the first fiber (F1) (reference) and the second fiber (F2), third fiber (F3) and fourth fiber (F4) are then 90°, 180° and 270° in a clockwise direction. Analogous considerations apply for other possible angles β.

The first fiber (F1) then has a first direction and the second fiber (F2) arranged at an angle β to the first fiber (F1) has a second direction. It is preferable when the first fiber (F1) and the second fiber (F2) have a similar number of parts (FT). “Parts (FT) of the fiber (F)” is to be understood as meaning in the context of the present invention the first part (FT1), the second part (FT2) and the third part (FT3) and also the further parts of the fiber (F) described hereinbelow.

“Similar” in the present context is to be understood as meaning that the difference between the number of parts (FT) of the fiber (F) in each direction relative to the other direction is <30%, preferably <10% and especially preferably <2%.

The fiber (F) may have further parts. It may have for example 4 to 80 000 further parts, preferably 8000 to 32 000 further parts.

For example the fiber (F) may have a fourth part (FT4), a fifth part (FT5), a sixth part (FT6) and a seventh part (FT7). The fourth part (FT4) and the sixth part (FT6) in each case have a first region (FB14, FB16) which is located inside the molding and surrounded by the foam and a second region (FB24, FB26) which projects from the first side of the foam. The fifth part (FT5) of the fiber (F) then connects the second part (FT2) and the fourth part (FT4) of the fiber (F) and the seventh part (FT7) of the fiber (F) connects the fourth part (FT4) and the sixth part (FT6) of the fiber (F). All first regions (FB1) of the parts (FT) of the fiber (F) are separated from one another by the foam.

When the fiber (F) has more than the seven parts described by way of example it will be appreciated by those skilled in the art by reference to the elucidations hereinabove how the more than seven parts are arranged in the molding and which of the more than seven parts have a first region (FB1) and a second region (FB2).

The first region (FB1) of the first part (FT1) of the fiber (F) and the first region (FB12) of the second part (FT2) of the fiber (F) are at a distance a from one another.

The distance a may take any desired value. It is preferable when the distance a is in the range from 3 to 100 mm, preferably in the range from 7 to 30 mm and especially preferably in the range from 10 to 20 mm.

When the at least one fiber (F) has further parts, for example a fourth part (FT4), a fifth part (FT5), a sixth part (FT6) and a seventh part (FT7), it is preferable when the first regions (FB1) of directly adjacent parts (FT) of the fiber (F) have the same distance a.

According to the invention the third part (FT3) of the fiber (F) connects the first part (FT1) and the second part (FT2) of the fiber (F) and is arranged on the second side of the foam. It is preferable here when the third part (FT3) of the fiber (F) is aligned parallel to the second side of the foam.

In the context of the present invention “parallel” is to be understood as meaning that the third part (FT3) of the fiber (F) may not only be aligned precisely parallel to the second side of the foam but may also deviate from parallel alignment by an angle of +/−10°, preferably of +/−5°, especially preferably of +/−1°.

It will further be appreciated by those skilled in the art that it is also possible for only a section of the third part (FT3) of the fiber (F) to be aligned parallel to the second side of the foam. For example two sections of the third part (FT3) of the fiber (F) may be curved since these are respectively connected to the first part (FT1) and the second part (FT2) of the fiber (F) and the third part (FT3) may be aligned parallel to the second side of the foam only with its middle section.

It is also preferable when the third part (FT3) of the fiber (F) is in contact with the second side of the foam. It will be appreciated by those skilled in the art that it is also possible for only a section of the third part (FT3) of the fiber (F) to be in contact with the second side of the foam. For example two sections of the third part (FT3) of the fiber (F) may be curved since they are respectively connected to the first part (FT1) of the fiber (F) and the second part (FT2) of the fiber (F) and the third part (FT3) of the fiber (F) may be in contact with the second side of the foam only with its middle section.

It is thus possible for only a section of the third part (FT3) of the fiber (F) to be in contact with the second side of the foam.

It is especially preferable when the third part (FT3) of the fiber (F) is aligned parallel to the second side of the foam and that the third part (FT3) of the fiber (F) is in contact with the second side of the foam. The above-described elucidations and preferences apply in each case here.

According to the invention the second region (FB21) of the first part (FT1) of the fiber (F) projects from the first side of the foam. The second region (FB22) of the second part (FT2) of the fiber (F) likewise projects from the first side of the foam. The second region (FB21) of the first part (FT1) of the fiber (F) and the second region (FB22) of the second part (FT2) of the fiber (F) may have any desired shapes. For example they may be loop-shaped or in the shape of cut-open loops. Loop-shaped is also described as “noose-shaped”.

It is therefore preferable when the second region (FB21) of the first part (FT1) of the fiber (F) is loop-shaped and/or the second region (FB22) of the second part (FT2) of the fiber (F) is loop-shaped. It is preferable when the second region (FB21) of the first part (FT1) of the fiber (F) and the second region (FB22) of the second part (FT2) of the fiber (F) are loop-shaped.

It will be appreciated that when the fiber (F) has further parts the above-described elucidations and preferences for the first part (FT1), the second part (FT2) and the third part (FT3) apply correspondingly for the respective further part.

When the fiber (F) has further parts it is preferable when at least 80%, preferably at least 90%, of the second regions (FB2) of the parts (FT) of the fiber (F) are loop-shaped. It is especially preferable when at least 80%, preferably at least 90%, especially preferably at least 95%, of the second regions (FB2) of the parts (FT) of the fiber (F) are loop-shaped and the molding has 500 to 40 000 second regions (FB2) of the fiber (F) per m².

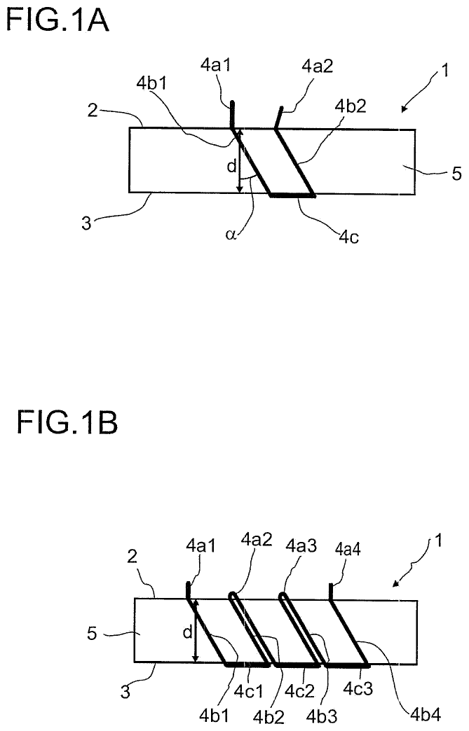

FIG. 1a shows an exemplary molding (1) according to the invention. The reference numerals (2) and (3) label the first side and the second side of the molding. A fiber (F) having a first part (4a1 and 4b1), a second part (4a2 and 4b2) and a third part (4c) has been introduced into the molding. The first region (4b1) of the first part (FT1) of the fiber (F) and the first region (4b2) of the second part (FT2) of the fiber (F) are located inside the foam (5). The second region (4a1) of the first part of the fiber (F) and the second region (4a2) of the second part (FT2) of the fiber (F) project from the first side (2) of the foam (5). The third part (4c) of the fiber (F) connects the first part (FT1) of the fiber (F) with the second part (FT2) of the fiber (F) and is arranged at the second side (3) of the foam (5).

FIG. 1b shows a further preferred embodiment of the molding according to the invention in which the fiber (F) has further parts. The first part, the second part, the fourth part and the sixth part of the fiber are with a first region (4b1, 4b2, 4b3 and 4b4) in each case located inside the foam and a second region (4a1, 4a2, 4a3 and 4a4) in each case projects from the first side (2) of the foam (5). The third part (4c1) connects the first part and the second part of the fiber and is arranged at the second side (3) of the foam (5). The fifth part (4c2) connects the second part with the fourth part of the fiber and is arranged at the second side (3) of the foam (5). The seventh part (4c3) connects the fourth part of the fiber with the sixth part of the fiber and is arranged at the second side (3) of the foam (5).

According to the invention the molding is obtainable by a process comprising the following steps a) to k):
a) providing the foam,
b) providing the fiber (F) on the second side of the foam,
c) providing a first hole per fiber (F) in the foam, wherein the first hole extends from the first side to the second side of the foam,
d) providing a second hole per fiber (F) in the foam, wherein the second hole extends from the first side to the second side of the foam,
e) passing through a needle from the first side of the foam through the first hole to the second side of the foam,
f) securing a first part (FT1) of the fiber (F) to the needle on the second side of the foam,
g) returning the needle together with the first part (FT1) of the fiber (F) through the first hole to the first side of the foam,
h) passing through a needle from the first side of the foam through the second hole to the second side of the foam,
i) securing the second part (FT2) of the fiber (F) to the needle on the second side of the foam,
j) returning the needle together with the second part (FT2) of the fiber (F) through the second hole to the first side of the foam and
k) obtaining the molding.

The above-described explanations and preferences for the foam present in the molding apply correspondingly to the foam provided in step a).

The foam may be provided in step a) by any methods known to those skilled in the art. It is preferably provided according to the above-described extrusion process.

The foam provided in step a) preferably has a layer (S2) on the first side and/or on the second side. The below-described elucidations and preferences for the layer (S2) optionally present in the panel according to the invention apply correspondingly to the layer (S2).

The elucidations and preferences described hereinabove for the fiber (F) present in the molding apply correspondingly to the fiber (F) provided in step b).

It is preferable when the diameter of the first hole and of the second hole are smaller than double the diameter of the fiber (F).

It is preferable according to the invention when the steps c) and e) are performed simultaneously and/or the steps d) and h) are performed simultaneously. Thus in this case the first hole per fiber (F) in the foam is produced by passing through a needle from the first side of the foam to the second side of the foam. Accordingly, the second hole per fiber (F) is produced by passing through a needle from the first side of the foam to the second side of the foam.

It is particularly preferred when the steps c), d), e) and h) are performed simultaneously. Thus in this embodiment a first needle is employed for the first hole and a second needle is employed for the second hole.

As described hereinabove it is preferable when the foam provided in step a) has a layer (S2) on the first side and/or on the second side. In this case in step c) the first hole per fiber (F) is additionally produced in the layer (S2) and in step d) the second hole per fiber (F) is additionally produced in the layer (S2) and in steps e) and h) the needle is additionally passed through the layer (S2).

It will be appreciated that when the fiber (F) has further parts the further parts having a first region (FB1) and a second region (FB2) are introduced into the foam according to the steps described hereinabove and that further holes are then also produced in the foam according to the steps c) and d) described hereinabove, for example a third hole, a fourth hole and a fifth hole. The above-described elucidations and preferences then apply correspondingly.

The present invention therefore also provides a process for producing a molding according to the invention, comprising the steps a) to k):
a) providing the foam,
b) providing the fiber (F) on the second side of the foam,
c) providing a first hole per fiber (F) in the foam, wherein the first hole extends from the first side to the second side of the foam,
d) providing a second hole per fiber (F) in the foam, wherein the second hole extends from the first side to the second side of the foam,
e) passing through a needle from the first side of the foam through the first hole to the second side of the foam,
f) securing the first part (FT1) of the fiber (F) to the needle on the second side of the foam,
g) returning the needle together with the first part (FT1) of the fiber (F) through the first hole to the first side of the foam,
h) passing through a needle from the first side of the foam through the second hole to the second side of the foam,
i) securing the second part (FT2) of the fiber (F) to the needle on the second side of the foam,
j) returning the needle together with the second part (FT2) of the fiber (F) through the second hole to the first side of the foam and
k) obtaining the molding.

The above-described elucidations and preferences for the process by which the molding is obtainable apply correspondingly to the process according to the invention.

It is therefore preferable when the steps c) and e) are performed simultaneously and/or the steps d) and h) are performed simultaneously and it is particularly preferable when the steps c), d), e) and h) are performed simultaneously.

The process for producing the molding according to the invention therefore preferably comprises the following steps a-1) to k-1):
a-1) providing the foam,
b-1) providing the fiber (F) on the second side of the foam,
c-1) producing a first hole per fiber (F) in the foam, wherein the first hole extends from the first side to the second side of the foam and wherein the first hole is produced by passing through a needle through the foam,
d-1) securing the first part (FT1) of the fiber (F) to the needle on the second side of the foam,
e-1) returning the needle together with the first part (FT1) of the fiber (F) through the first hole to the first side of the foam,
f-1) producing a second hole per fiber (F) in the foam, wherein the second hole extends from the first side to the second side of the foam and wherein the second hole is produced by passing through a needle through the foam,
g-1) securing the second part (FT2) of the fiber (F) to the needle on the second side of the foam,
h-1) returning the needle together with the second part (FT2) of the fiber (F) through the second hole to the first side of the foam and
i-1) obtaining the molding,

the steps c-1) and f-1) and also d-1) and g-1) and also e-1) and h-1) preferably being performed simultaneously.

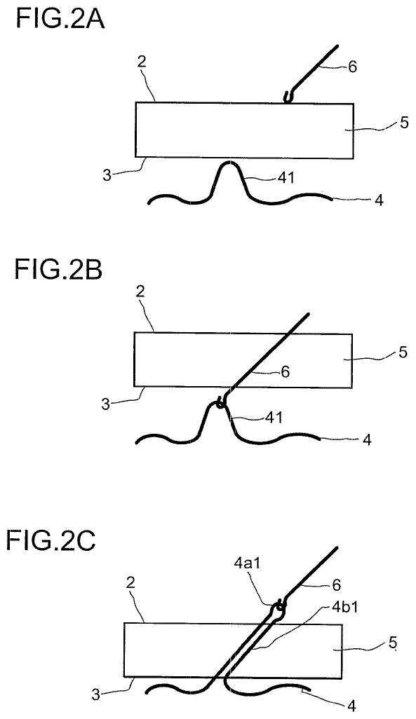

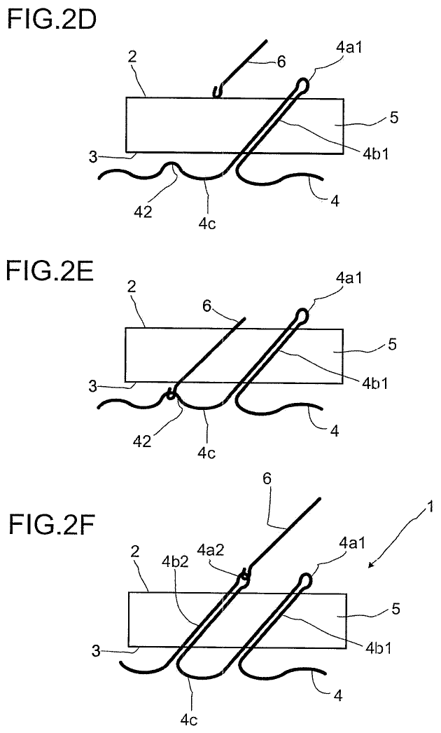

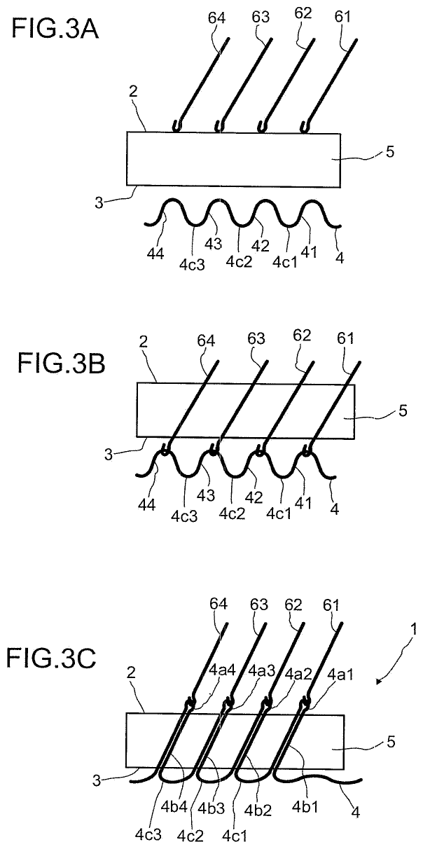

FIGS. 2 and 3 show preferred embodiments of the process according to the invention for producing a molding according to the invention.

FIG. 2 shows the production of a molding according to the invention, wherein the steps c) and e) and also the steps d) and h) are performed simultaneously.

In FIG. 2a a foam (5) having a first side (2) and a second side (3) is provided. On the second side a fiber (4) having a first part (41) is provided. On the first side (2) a needle (6) is provided.

In FIG. 2b by passing through the needle (6) from the first side (2) to the second side (3) of the foam (5) a hole is produced and on the second side (3) of the foam the first part (41) of the fiber (4) is hooked into the needle (6).

In FIG. 2c the needle (6) was returned from the second side (3) of the foam (5) to the first side (2) through the second hole. The first part of the fiber (4) was likewise passed through the hole and therefore a first region (4b1) of the first part of the fiber (4) is located inside the foam (5) and a second region (4a1) of the first part of the fiber (4) projects from the first side (2) of the foam (5).

In FIG. 2d the needle (6) has been unhooked and the second region (4a1) of the first part of the fiber (4) is therefore loop-shaped/noose-shaped. It would likewise be possible to cut through the second region (4a1) of the first part of the fiber (4) to unhook the needle (6).

In FIG. 2e the second hole has been produced by passing through the needle (6) from the first side (2) to the second side (3) of the foam (5) and the second part (42) of the fiber (4) has been hooked into the needle (6), wherein the first part of the fiber is connected to the second part (42) of the fiber (4) via the third part (4c).

In FIG. 2f the needle (6) has been returned and therefore the second part of the fiber (4) is with a first part (4b2) located inside the foam (5) and the second region (4a2) of the second part of the fiber (4) projects from the first side (2) of the foam (5). This affords the molding (1) according to the invention. The needle (6) may be unhooked from the second region (4a2) of the second part of the fiber (4) and the second region (4a2) is therefore loop-shaped/noose-shaped. It is likewise possible to cut through the second region (4a2) to unhook the needle (6).

FIG. 3 shows the embodiment in which the first and the second hole and the further holes are produced simultaneously. To this end, and as shown in FIG. 3a, a first needle (61), a second needle (62), a third needle (63) and a fourth needle (64) are provided on the first side (2) of the foam (5) while provided on the second side (3) of the foam (5) is a fiber (4) having a first region (41), a second region (42), a fourth region (43) and a sixth region (44) which are respectively connected to one another via a third region (4c1), a fifth region (4c2) and a seventh region (4c3).

In FIG. 3b the first needle (61), the second needle (62), the third needle (63) and the fourth needle (64) were passed through the foam (5) from the first side (2) of the foam (5) to the second side (3) of the foam (5) to produce a first hole, a second hole, a third hole and a fourth hole and the first part (41) of the fiber (4) was hooked into the first needle (61), the second part (42) of the fiber (4) was hooked into the second needle (62), the fourth part (43) of the fiber (4) was hooked into the third needle (63) and the sixth part (44) of the fiber (4) was hooked into the fourth needle (64).

It is apparent in FIG. 3c that the first needle (61) was returned through the first hole, the second needle (62) through the second hole, the third needle (63) through the third hole and the fourth needle (64) through the fourth hole. This returning was carried out simultaneously so that the first regions (4b1, 4b2, 4b3, 4b4) of the fiber (4) are located inside the foam (5) and the second regions (4a1, 4a2, 4a3, 4a4) of the fiber (4) project from the first side (2) of the foam (5). The third part (4c1), the fifth part (4c2) and the seventh part (4c3) each connect the other parts to one another.

The present invention also provides a panel comprising at least one molding according to the invention and at least one layer (S1). A “panel” may also be referred to among specialists in the art as a “sandwich”, “sandwich material”, “laminate” and/or “composite article”.

In a preferred embodiment of the panel the panel comprises two layers (S1) and the two layers (S1) are each attached at a side of the molding that is opposite the respective other side of the molding.

In one embodiment of the panel according to the invention the layer (S1) comprises at least one resin, the resin preferably being a reactive thermosetting or thermoplastic resin, the resin more preferably being based on epoxides, acrylates, polyurethanes, polyamides, polyesters, unsaturated polyesters, vinyl esters or mixtures thereof, the resin in particular being an amine-curing epoxy resin, a latent-curing epoxy resin, an anhydride-curing epoxy resin or a polyurethane composed of isocyanates and polyols. Such resin systems are known to those skilled in the art, for example from Penczek et al. (Advances in Polymer Science, 184, pages 1-95, 2005), Pham et al. (Ullmann's Encyclopedia of Industrial Chemistry, Vol. 13, 2012), Fahnler (Polyamides, Kunststoff Handbuch 3/4, 1998) and Younes (WO12134878 A2).

It is additionally preferable for the at least one layer (S1) of the panel to also comprise at least one fibrous material, wherein
i) the fibrous material comprises fibers in the form of one or more plies of chopped fibers, nonwovens, non-crimp fabrics, knits and/or wovens, preferably in the form of non-crimp fabrics or wovens, particularly preferably in the form of non-crimp fabrics or wovens having a basis weight per non-crimp fabric/woven of 150 to 2500 g/m², and/or
ii) the fibrous material comprises fibers of organic, inorganic, metallic or ceramic fibers, preferably polymeric fibers, basalt fibers, glass fibers, carbon fibers or natural fibers, particularly preferably glass fibers or carbon fibers.

The elucidations described above apply to the natural fibers and the polymeric fibers.

A layer (S1) additionally comprising at least one fibrous material is also referred to as a fiber-reinforced layer, in particular as a fiber-reinforced resin layer provided that the layer (S1) comprises a resin.

Also preferred according to the invention is a panel where at least one of the following options is fulfilled:
i) the second region (FB21) of the first part (FT1) of the fiber (F) and/or the second region (FB22) of the second part (FT2) of the fiber (F) is in partial or complete contact, preferably complete contact, with the layer (S1) and/or
ii) the panel has at least one layer (S2) between at least one side of the molding and at least one layer (S1), the layer (S2) preferably being composed of two-dimensional fiber materials or polymeric films, more preferably of glass fibers or carbon fibers in the form of nonwovens, non-crimp fabrics or wovens, and/or
iii) the panel comprises two layers (S1) and the two layers (S1) are each attached at a side of the molding that is opposite the respective other side of the molding.

The present invention further provides a process for producing the panel according to the invention in which the at least one layer (S1) is produced, applied and cured on a molding according to the invention in the form of a reactive viscous resin, preferably by liquid impregnation methods, particularly preferably by pressure- or vacuum-assisted impregnation methods, especially preferably by vacuum infusion or pressure-assisted injection methods, most preferably by vacuum infusion. Liquid impregnation methods are known as such to those skilled in the art and are described in detail, for example, in Wiley Encyclopedia of Composites (2nd Edition, Wiley, 2012), Parnas et al. (Liquid Composite Moulding, Hanser, 2000) and Williams et al. (Composites Part A, 27, p. 517-524, 1997).

Various auxiliary materials can be used for producing the panel according to the invention. Suitable auxiliary materials for production by vacuum infusion include, for example, vacuum film, preferably made of nylon, vacuum sealing tape, flow aids, preferably made of nylon, separation film, preferably made of polyolefin, tearoff fabric, preferably made of polyester, and a semipermeable film, preferably a membrane film, particularly preferably a PTFE membrane film, and absorption fleece, preferably made of polyester. The choice of suitable auxiliary materials is guided by the component to be manufactured, the process chosen and the materials used, specifically the resin system. When employing resin systems based on epoxide and polyurethane it is preferable to use flow aids made of nylon, separation films made of polyolefin, tearoff fabric made of polyester and semipermeable films as PTFE membrane films and absorption fleeces made of polyester.

These auxiliary materials can be used in various ways in the processes for producing the panel according to the invention. It is particularly preferable when panels are produced from the moldings by applying fiber-reinforced outer plies by means of vacuum infusion. In a typical construction, to produce the panel according to the invention, fibrous materials and optionally further layers are applied to the top side and the bottom side of the moldings. Subsequently, tearoff fabric and separation films are positioned. The infusion of the liquid resin system may be carried out using flow aids and/or membrane films. Particular preference is given to the following variants:
i) use of a flow aid on just one side of the construction, and/or
ii) use of a flow aid on both sides of the construction, and/or
iii) construction with a semipermeable membrane (VAP construction); the latter is preferably draped over the full area of the molding, on which flow aids, separation film and tearoff fabric are used on one or both sides, and the semipermeable membrane is sealed with respect to the mold surface by means of vacuum sealing tape, the absorption fleece is inserted on the side of the semipermeable membrane remote from the molding, as a result of which the air is evacuated upward over the full area, and/or
iv) use of a vacuum pocket made from membrane film, which is preferably positioned at the opposite gate side of the molding, by means of which the air is evacuated from the opposite side to the gate.

The construction is subsequently equipped with gates for the resin system and gates for the evacuation. Finally, a vacuum film is applied over the entire construction and sealed with sealing tape, and the entire construction is evacuated. After the infusion of the resin system, the reaction of the resin system takes place with maintenance of the vacuum.

The present invention also provides for the use of the molding according to the invention or of the panel according to the invention for rotor blades in wind turbines, in the transport sector, in the construction sector, in automobile construction, in shipbuilding, in rail vehicle construction, for container construction, for sanitary installations and/or in aerospace.

1.-13. (canceled)

14. A molding comprising a foam which has a first side and a second side and at least one fiber (F) which has a first part (FT1), a second part (FT2) and a third part (FT3), wherein
a first region (FB11) of the first part (FT1) of the fiber (F) is located inside the molding and surrounded by the foam and a second region (FB21) of the first part (FT1) of the fiber (F) projects from the first side of the foam and
a first region (FB12) of the second part (FT2) of the fiber (F) is located inside the molding and surrounded by the foam and a second region (FB22) of the second part (FT2) of the fiber (F) projects from the first side of the foam and
the third part (FT3) of the fiber (F) connects the first part (FT1) and the second part (FT2) of the fiber (F) and is arranged on the second side of the foam and
the first region (FB11) of the first part (FT1) of the fiber (F) and the first region (FB12) of the second part (FT2) of the fiber (F) are not in contact,
wherein the molding is obtained by a process comprising the following steps a) to k):
a) providing the foam,
b) providing the fiber (F) on the second side of the foam,
c) providing a first hole per fiber (F) in the foam, wherein the first hole extends from the first side to the second side of the foam,
d) providing a second hole per fiber (F) in the foam, wherein the second hole extends from the first side to the second side of the foam,
e) passing through a needle from the first side of the foam through the first hole to the second side of the foam,
f) securing the first part (FT1) of the fiber (F) to the needle on the second side of the foam,
g) returning the needle together with the first part (FT1) of the fiber (F) through the first hole to the first side of the foam,
h) passing through a needle from the first side of the foam through the second hole to the second side of the foam,
i) securing the second part (FT2) of the fiber (F) to the needle on the second side of the foam,
j) returning the needle together with the second part (FT2) of the fiber (F) through the second hole to the first side of the foam and
k) obtaining the molding.

15. The molding according to claim 14, wherein
i) the first region (FB11) of the first part (FT1) of the fiber (F) is aligned parallel to the first region (FB12) of the second part (FT2) of the fiber (F) and/or
ii) the third part (FT3) of the fiber (F) is aligned parallel to the second side of the foam and/or
iii) the third part (FT3) of the fiber (F) is in contact with to the second side of the foam and/or
iv) the second region (FB21) of the first part (FT1) of the fiber (F) is loop-shaped and/or the second region (FB22) of the second part (FT2) of the fiber (F) is loop-shaped, it being preferable when the second region (FB21) of the first part (FT1) of the fiber (F) and the second region (FB22) of the second part (FT2) of the fiber (F) are loop-shaped.

16. The molding according to claim 14, wherein the foam has been produced from a particle foam, an extruded foam, a reactive foam and/or a batch foam.

17. The molding according to claim 14, wherein the foam is based on at least one polymer selected from the group consisting of polystyrene, polyester, polyphenylene oxide, a copolymer produced from phenylene oxide, a copolymer produced from styrene, polyaryl ether sulfone, polyphenylene sulfide, polyaryl ether ketone, polypropylene, polyethylene, polyamide, polyamide imide, polyether imide, polycarbonate, polyacrylate, polylactic acid, polyvinyl chloride, polyurethane, and mixtures thereof.

18. The molding according to claim 14, wherein
i) the foam provided in step a) has a layer (S2) on the first side and/or on the second side, wherein in step c) the first hole per fiber (F) is additionally produced in the layer (S2) and in step d) the second hole per fiber (F) is additionally produced in the layer (S2) and in steps e) and h) the needle is additionally passed through the layer (S2) and/or
ii) the steps c) and e) are performed simultaneously and/or the steps d) and h) are performed simultaneously.

19. The molding according to claim 14, wherein
i) the fiber (F) is a single fiber or a fiber bundle, and/or
ii) the fiber (F) is an organic, inorganic, metallic or ceramic fiber or a combination thereof, and/or
iii) the fiber (F) in step b) is provided in the form of a fiber bundle having a number of individual fibers per bundle of at least 10, in the case of glass fibers and 1000 to 50 000 in the case of carbon fibers, and/or
iv) the first part (FT1) of the fiber (F) has been introduced into the foam at an angle α_{FT1} of 0° to 60°, or of 10° to 70°, relative to the thickness direction (d) of the molding and/or
v) the second part (FT2) of the fiber (F) has been introduced into the foam at an angle α_{FT2} of 0° to 60°, or of 10° to 70°, relative to the thickness direction (d) of the molding and/or
vi) the first side of the foam is opposite the second side of the foam and/or

20. A process for the production of a molding according to claim 14, comprising the steps a) to k):
a) providing the foam,
b) providing the fiber (F) on the second side of the foam,
c) providing a first hole per fiber (F) in the foam, wherein the first hole extends from the first side to the second side of the foam,
d) providing a second hole per fiber (F) in the foam, wherein the second hole extends from the first side to the second side of the foam,
e) passing through a needle from the first side of the foam through the first hole to the second side of the foam,
f) securing the first part (FT1) of the fiber (F) to the needle on the second side of the foam,
g) returning the needle together with the first part (FT1) of the fiber (F) through the first hole to the first side of the foam,
h) passing through a needle from the first side of the foam through the second hole to the second side of the foam,
i) securing the second part (FT2) of the fiber (F) to the needle on the second side of the foam,
j) returning the needle together with the second part (FT2) of the fiber (F) through the second hole to the first side of the foam and
k) obtaining the molding.

21. A panel comprising at least one molding according to claim 14 and at least one layer (S1).

22. The panel according to claim 21, wherein the layer (S1) comprises at least one resin.

23. The panel according to claim 21, wherein the layer (S1) additionally comprises at least one fibrous material, wherein
i) the fibrous material comprises fibers in the form of one or more plies of chopped fibers, nonwovens, non-crimp fabrics, knits and/or wovens, and/or
ii) the fibrous material comprises organic, inorganic, metallic or ceramic fibers.

24. The panel according to any of claim 21, wherein
i) the second region (FB21) of the first part (FT1) of the fiber (F) and/or the second region (FB22) of the second part (FT2) of the fiber (F) is in partial or complete contact with the layer (S1) and/or
ii) the panel comprises between at least one side of the molding and at least one layer (S1) at least one layer (S2), the layer (S2) being composed of sheetlike fiber materials or polymeric films, and/or
iii) the panel comprises two layers (S1) and the two layers (S1) are each attached at a side of the molding that is opposite the respective other side of the molding.

25. A process for producing a panel according to claim 21, wherein the at least one layer (S1) is produced, applied and cured on the at least one molding in the form of a reactive viscous resin, by liquid impregnation methods.

26. A rotor blade in a wind turbine comprising the molding according to claim 14.

27. The molding according to claim 14, wherein the foam has been produced from an extruded foam produced in a process comprising the following steps:
I) providing a polymer melt in an extruder,
II) introducing at least one blowing agent into the polymer melt provided in step I) to obtain a foamable polymer melt,
III) extruding the foamable polymer melt obtained in step II) from the extruder through at least one die aperture into an area at lower pressure, with expansion of the foamable polymer melt to obtain an expanded foam,
IV) calibrating the expanded foam from step III) by passing the expanded foam through a shaping tool to obtain the extruded foam,
V) optional material-removing processing of the extruded foam obtained in step IV),
wherein
i) the polymer melt provided in step I) optionally comprises at least one additive, and/or
ii) at least one additive is optionally added to the polymer melt during step II) and/or to the foamable polymer melt between step II) and step III), and/or
iii) at least one additive is optionally applied during step III) to the expanded foam and/or during step IV) to the expanded foam, and/or
at least one layer (S2) is optionally applied to the extruded foam during and/or directly after step IV).
